(19) United States
(12) Patent Application Publication
(10) Pub. No.: US 2008/0182060 A1
(43) Pub. Date: Jul. 31, 2008

(54) Manufacturing of Multi-Plate For Improved Optical Storage

(76) Inventors: David Livshits, Ashdod (IL); Ortal Alpert, Jerusalem (IL); Yair Salomon, Jerusalem (IL)

Correspondence Address: BROWDY AND NEIMARK, P.L.L.C.;624 NINTH STREET, NW, SUITE 300, WASHINGTON, DC, 20001-5303, US

(21) Appl. No.: 11/813,837

(22) PCT Filed: Jan. 12, 2006
(86) PCT No.: PCT/IL2006/000053

§ 371 Date: Jul. 12, 2007

(30) Foreign Application Priority Data
Jan. 12, 2005 (US) 60643112

(51) Int. Cl. G11B 7/24; B29C 65/48; B29C 65/72

(52) U.S. Cl. 428/65.2; 156/60; 156/250; 428/64.4

(57) ABSTRACT

In accordance with the invention a new optical data carrier and methods for its production are provided. The optical data carrier of the invention is characterized in that different plates have different concentrations.

### FIELD OF THE INVENTION

The invention is generally in the field of three dimensional optical data carriers and their manufacture. The optical data carriers of the invention can be used for recording and reading and in some cases are also re-writable.

### BACKGROUND OF THE INVENTION

Optical storage is one of the most popular data storage means. The information or data may be recorded, stored, read and erased on the three-dimensional information carrier usually having the form of a disc. Carriers may be monolithic disc-like bodies made of a transparent or translucent polymer material. The material is usually a polymer such as polymethylmethacrylate (PMMA) with bound active moieties that are capable of changing their state from one isomeric form to another upon interaction with electromagnetic energy, such as laser radiation. The information is recorded on the carrier as series of three-dimensional regular marks or oblong and tilted data marks such as disclosed in PCT application, publication No. WO 2005/015552.

The storage capacity of a three-dimensional (3D) carrier may exceed hundreds of Gigabytes and it is proportional to the volume of the carrier and particularly to the volume containing the active moiety. Because of this, the three-dimensional carriers have an active thickness that significantly exceeds the thickness of conventional discs. For example, a typical three-dimensional two-photon terabyte carrier would typically have an active thickness of 1 to 6 millimeter.

Recording and reading of information of a two photon, three-dimensional carrier may be performed by one or two laser beams termed “activation” or heating beam(s) and a recording beam. Typically, the activation beam changes the energetic state at a particular recording location (by 1-photon absorption, e.g. at about 980 nm) enabling the recording beam to change the active moiety state from one isomeric form to another or what is termed trans-cis transition (by 2-photon absorption e.g. at about 670 nm) to record or erase the information. Typically, the activating beam is a different beam than the recording beam. Alternatively, the recording beam may also the activating beam which, in turn, may be different than the read beam.

Being relatively thick, two-photon 3D optical data carriers are typically produced by casting in a manner that causes relatively small distortions in their geometry. However, injection and extrusion production methods are also known. In the latter manufacturing process, cooling of the relatively thick carrier may take a considerable amount of time and the chemical steady state would be established at a relatively high temperature resulting in a high level of residual high-level energetic transitions in the carrier. These residual transitions impart lower signal-to-noise ratio in reading signals, once put in use as data storage. Casting results gives rise to a lower amount of residual high-level energetic transitions and better carrier recording properties.

One of the problems associated with such a data carrier is that the activation beam penetrating to deeper layers of the carrier, is partially absorbed by the material's upper layers and thus the power for recording in inner layers should typically be increased, as compared to the power required for recording in outer layers. Increase in the power of the activation beam, required to compensate for the absorption is difficult to achieve.

Information or data marks may be of sub-micron size. Recording, reading or erasing of such small marks requires high mechanical accuracy of the disc, which is in case of thick discs is difficult to obtain through casting. The high rotational speed of the disc, desired for fast recording and reading of data, may give rise to further distortions of the geometry of such a disc eventually limiting the accuracy and speed of recording or reading of submicron marks. The mechanical properties of the photo-active medium may also become a limiting factor if, for example, the active material comprising the active groups is too fragile or flexible.

The ability to have the same predictable laser power for every recording or reading depth would simplify the processes.

### SUMMARY OF THE INVENTION

In accordance with the invention a new optical data carrier is provided. The optical data carrier of the invention is characterized in that different layers have different concentrations of the reactive, irradiation-absorbing material. The term “layer” should be understood in its physical sense, namely as meaning volume portions that are all equidistant from the external top or bottom face of the data carrier. In other words, the data carrier of the invention is characterized in that there are different concentrations of the irradiation-absorbing material at different depths away from its upper (or lower) surface, the upper surface being that from which data is written into or read from said data carrier. The different concentrations typically give rise to a depth-related concentration gradient, with the concentration increasing (monotonically or in a step-wise fashion) in relation to the distance from (or depth) said upper surface, all regions that are equidistant from the upper surface, have substantially the same concentration of the irradiation-absorbing material.

In accordance with the invention there is thus provided a three-dimensional (3D) data carrier comprising a plurality of layers characterized in that each of said layers contains a different concentration of irradiation-absorbing material.

The term “irradiation” typically denotes infrared (IR), visible or ultraviolet (UV) light irradiation. The “irradiation-absorbing material” may be any molecule or a group of molecules that can absorb the electromagnetic, e.g. light irradiation and generate heat through non-irradiative or convection mechanisms, emit photons through a fluorescence mechanism or undergo a conformational change, e.g., a switch between cis and trans configurations.

In accordance with an embodiment of the invention, the concentration of the irradiation-absorbing material increases from one surface of the data carrier towards surfaces away therefrom. Typically, the concentration of irradiation-absorbing material in different layers is selected such as to ensure equal absorption of power of an irradiating beam at different depths of said carrier

In accordance with another preferred embodiment, the 3D data carrier is produced as a laminate assembled from a plurality of plates or sheets adhered to one another. The sheets or plates are typically adhered to one another by the use of an adhesive, which once cured should have a refractive index similar to that of the polymeric material from which the sheets or plates are made of. By one embodiment, the individual plates or sheets have different concentrations of the irradiation-absorbing material. This means that the plates or sheets comprise some sheets or plates with different concentrations of the irradiation-absorbing material than other sheets or plates in said carrier. By some embodiments, each such sheet or plate has a different concentration of said material, whereby a gradual gradient of concentrations is obtained. By another embodiment, several of the assembled sheets or plates may have one concentration of said material, several others another concentration, etc. Such a 3D data carrier thus comprises two or more groups of two or more sheets or plates each, all sheets or plates of one group have the same concentration of said material different than that of any other of said two or more groups. In said 3D carrier several sheets or plates with one concentration of said material will typically be all adjacent one another and will constitute one group, sheets with another concentration another group, etc. While there will still be a gradient of concentrations in such case, the concentration gradient throughout the medium will be less gradual or rather more a stepwise gradient.

By one embodiment of the invention, the irradiation-absorbing material is incorporated also in the adhesive. This may permit different plates or sheets in the disc of the invention to have the same concentration of the irradiation-absorbing material, the different concentration between the plates being obtained by including different concentrations thereof in the different adhesive layers that adhere different plates or sheets to one another. By some embodiments of the invention the different sheets or plates that are assembled together to form the disc have no irradiation-absorbing material and these are included only in the adhesive material.

By another embodiment of the invention the different sheets or plates are adhered to one another through light-induced melting of a boundary layer between two adjacent sheets or plates.

The thickness of each layer is typically in the range of about 100-600 μm. The thickness may be selected based on minimization of the amount of high-energy transition formed at the steady state conditions in course of polymer cooling. Thick injected-molded plates cool slowly following their injection molding and therefore if the cooling is not sufficiently rapid, the molecules of the irradiation-absorbing material may undergo a heat-induced change in their configuration, for example a switch between their cis and trans isomeric states. Thus, molding thin plates that cool faster, may at times be preferred over thicker ones.

The 3D data carrier of the invention is typically, although not exclusively, in the form of a disc.

The invention also provides methods for producing said 3D data carriers comprising assembling and adhering together different plates or sheets. This may be either through the use of an adhesive, applied on at least one of two adjacent sheets, which may include also the irradiation-absorbing material, or through a light-induced transient (namely during the adhering step) melting of a boundary layer between adjacent plates or sheets. By one embodiment, different sheets or plates that are assembled together have different concentrations of irradiation-absorbing material. In accordance with another embodiment of the method, different assembled sheets or plates have the same concentration of said material, the method comprising adhering sheets or plates by the use of an adhesive that contains the irradiation-absorbing material, different sheets or plates being adhered with adhesive compositions comprising different concentrations of said material.

A method for the manufacture of three-dimensional information carrier in accordance with an embodiment of the invention comprises (i) laminating transparent or translucent sheets of polymer, (ii) a laser beam melts the boundary layer between said sheets of polymer and the melted layer bonds said sheets to each other, and (iii) a laser beam cuts out a plurality of said carriers from said laminated sheets.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic cross-section of illustrating an exemplary embodiment of a three-dimensional information carrier.

FIG. 2 is a schematic illustration of an apparatus for assembly or lamination of a three-dimensional data carrier, in accordance with an exemplary embodiment of the invention.

FIG. 3 is a schematic illustration of an improved gripper for non-contact handling of plates of the three-dimensional information carrier according to an exemplary embodiment of the invention.

FIG. 4 is a schematic illustration of the handling process of the three-dimensional information carrier plates by the improved gripper, according to an exemplary embodiment of the invention.

FIGS. 5A-5F are schematic cross-sections illustrating other exemplary embodiments of the three-dimensional information carrier.

FIGS. 6A-6B are illustrations of an additional assembly method of the three-dimensional information carrier.

FIGS. 7A-7C are schematic cross-sections illustrating other exemplary embodiment of a three-dimensional information carrier.

FIG. 8 is schematic illustration of a batch lamination process of polymer sheets used in manufacture of the three-dimensional information carrier according to an embodiment of the invention.

FIGS. 9A and 9B is a schematic illustration of the formed in the course of polymer sheets laminating process according to an embodiment of the invention.

FIG. 10 is a schematic illustration of a maimer of handling of laminated polymer sheets according to an embodiment of the invention.

FIG. 11 is a schematic illustration of handling of the three-dimensional information carriers cutout from the laminated polymer sheets according to an embodiment of the invention.

FIG. 12 is a schematic illustration of the details of handling a cutout three-dimensional information carrier according to an embodiment of the invention.

### DETAILED DESCRIPTION OF EXEMPLARY EMBODIMENTS

The structure and principles of the carrier and the assembly method described herein may be understood with reference to non-limiting exemplary embodiments depicted in the annexed drawings. In the drawings, like reference numerals in different figures denote elements with identical or similar function. The drawings are not necessarily to scale, emphasis instead being placed upon illustrating the principles of the method. As will be understood by an artisan, the depicted embodiments are but illustrative examples of the invention as disclosed and defined above.

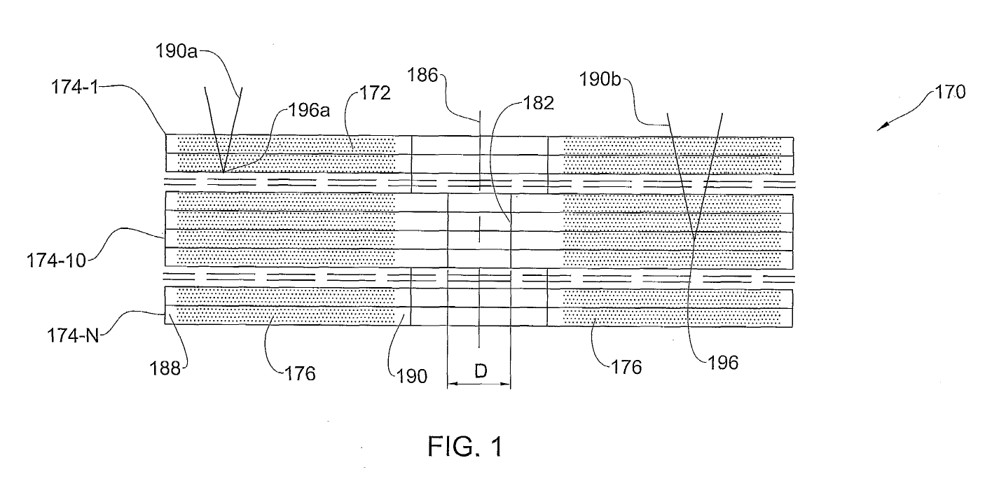

FIG. 1 is an illustration of one exemplary embodiment of a 3D optical data carrier generally designated 170. Carrier 170 consists of a plurality (N) of plates 174-1 to 174-N, made of polymeric material. The thickness of each plate is typically in the range of 100-600 μm, preferably in the range of 300-600 μm. The material is typically an acrylic-based polymer such as PMMA, with active groups and activating groups/additives, typically bound active moieties. The active groups are capable of changing their molecular state from one to another by a variety of different light-induced conformational changes and are capable of responding to interacting light in a way that is indicative of their state. The activating groups are irradiation-absorbing groups that are not necessarily capable of undergoing a change between states. The active groups may also have an activating capacity, namely the ability to activate other groups in their vicinity. The light is typically IR light, but may also be, by some embodiments, visible or UV. The type of conformational change depends on the nature of the active moiety and may be a switch between cis and trans configurations as in spiropyran and merocyanine forms, the “open” and “closed” forms of diarylethenes and fulgides, or the two forms of phenoxynaphthacene quinines.

Typical examples of active groups are stilbene derivative of the following formula (I):

Ar¹(R¹)C═C(R²)Ar² (I)

wherein Ar¹ and Ar² are phenyl groups optionally independently substituted with one or more groups selected from —C₁₋₆alkyls, —OC₁₋₆alkyl, —SC₁₋₆alkyl and, —C₁₋₆OH, thiols and their salts, NR′R″, R′ and R″ being independently hydrogen or C₁₋₆alkyl; R¹ and R² are substituents selected from nitrites selected from —(CH₂)ₙCN, n being 0, 1 or 2, halides, RCOOH, R being C₁₋₆alkyl, their C₁₋₆exters, or a nitro compound selected from —(CH₂)ₙNO₂, n being 0, 1 or 2.

C₁₋₆alkyls may be straight or branched alkyls, preferably a methyl, ethyl, propyl, isopropyl, butyl, sec-butyl or tert-butyl or pentyl groups; the nitrile is preferably a —CN group and the nitro compound is preferably an —NO₂ group

The polymeric material is typically prepared from modified monomers of the following formula (II):

Ar¹(R¹)C═C(R²)Ar²—M (II)

wherein Ar¹, Ar², R¹ and R² are as defined above and M is a polymerizable monomeric moiety. Specific example of M are acrylic monomers such as methylmethacrylate (MMA) and methylacrylate (MA) derivatives.

Exemplary modified monomers are those of the following formula (IV):

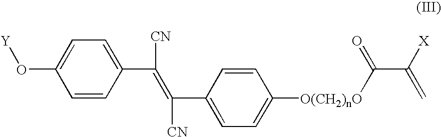

wherein X and Y are as defined above.

Particular examples of modified monomers of the following formula (IV) and (V):

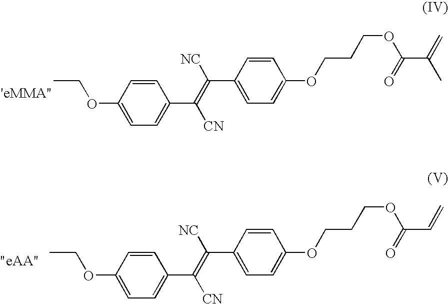

The stilbene derivatives can undergo a light-induced cis-trans isomerization and can in this way be converted from blank or unwritten form to written form upon interaction with appropriate light wavelength and energy, such as by laser irradiation.

The thickness of the plates may be chosen according to a number of different criteria, among them considerations of optimization of the cooling speed of the plates and reduction of the time in course of which steady state conditions in the polymer material would exist. Plates 174 may be produced by injection or extrusion, which have essentially higher throughput than casting, although the former means of preparation are limited to relatively thin plates.

The data is optically recorded on carrier 170 in form of marks 172 in practically any location in the 3D optical data carrier, although conveniently the marks are ‘written’ in a layered fashion to form a plurality of “virtual” layers 176. The distance between layers 176 may typically be in the range of 3-15 micron. The total thickness of the assembled carrier 170 may vary from 200 micron to more than 6 mm. Carrier 170, which is typically, as in the illustrated embodiment disk-shaped (accordingly, the optical data carrier will be referred to herein occasionally as “disc”), has a central mounting bore generally designated 182, symmetrical about rotational axis 186. The diameter of the bore may be different in different layers changing from a broader diameter in its external layers to narrower diameter D in inner ones. The portions 188 and 190, respectively at the disc's periphery and adjacent the central bore, are typically not-utilized for recording data marks, although they may be used to record auxiliary information.

Linear absorption of an electromagnetic radiation by medium, in which the radiation traverses, is proportional to the amount of encountered absorbing material, which is in turn proportional to the concentration of such absorbing material, the length (depth) of the path of the electromagnetic wave in the medium, and the (wavelength dependent) linear absorption coefficient. By way of example, if a laser beam 190a will be focused on a point 196a in the second layer, it will loose less power than beam 190b focused on a point 196b in a more inner layer, having before penetration into the medium power equal to beam 190a.

The activating laser beam activates the activating groups. The recording laser induces a change in the state of the active groups in the polymer material. The activation is performed by heating a microscopic volume of the optical data carrier 170 with a pulse of a fixed and predetermined duration. The ability to have the same predictable laser power for every recording or reading depth would simplify the processes and require less laser power. A material having a constant absorption in terms of power absorbed per optical path in the disk (Watt/cm) may provide this quality.

The focal point 196 of laser beam 190 is negligibly small relative to the disk or even plate thickness (less than a micron as compared with a few hundred microns to a few millimeters of the disc's thickness.) The intensity at the focal point of a laser beam at a certain depth is expressed in the following function (1) as:

I(x)=I*exp[−a*c(x)*x] (1)

Wherein:

I irradiation intensity at the surface of the disk

a absorption coefficient

x depth in the plate

e(x) concentration of the absorbing substance, namely that of the active groups or the activating dgrruops, as a function of depth in the plate that may be limited by saturation effects

It is desired according to a preferred embodiment of the invention that the absorbance at every depth should be constant as represented by the following function (2) as:

Constant=d/dx(I*exp[−a*c(x)*x])=−a*I*exp[−a*c(x)*x]*(x*d/dx c(x)+c(x)) (2)

The function (3) that determines the concentration of the heat absorbing material in the polymer may be as follows:

C(x)=−log(C₁*a*x)/a/x (3)

Wherein C₁ is a normalization constant (having units of concentration).

Substituting C(x) into the absorbance function and taking the derivatives, the attenuation gradient function (4) is obtained, as follows:

Δ=−I*C₁*a (4)

As can be seen, the above exemplary attenuation gradient function is a constant (and has units of Watt/cm).

The requirement for equal power of absorption at every depth of the disc dictates a depth-related increase in the concentration of the light energy absorbing group (irradiation-absorbing material). One embodiment for producing such a disc would be to include different concentrations of the active, light-absorbing groups in different plates of the disc. Thus, external layer 174-1 may have a concentration of such groups, different, typically lower than the concentration in deeper plates, e.g. 174-10 or 174-N.

The concentration of such groups is selected such so as to have approximately equal absorption of power from the activation beam per unit of depth of the carrier or disc.

According to an embodiment of the invention, the different plates of the disc, e.g. each with its different concentration of active light-absorbing groups, may be independently prepared as separate plates for subsequent assembly to form said disc. As will be appreciated, the invention is not limited in any way to such a manner of disc production. The different plates may be adhered to one another by the use of adhesives. A variety of different transparent adhesives, preferably such having a light refraction index similar to that of the polymer, may be used to attach or laminate plates 174 to each other.

According to one embodiment, active groups are included in the adhesive and following polymerization of the adhesive become immobilized in the cured adhesive layer and are typically bound to the polymeric backbone thereof. The concentration of the active groups in the adhesive may be different than the concentration thereof in the adjacent plates. The control of the concentration of the active groups may be an effective means for achieving a depth-dependent concentration of said active groups. At times, the plates may be made without such active groups which will thus be included only in the adhesive.

Lamination of a number of plates 174 into one carrier disc 170 increases the mechanical strength of an optical disc. It is an extremely effective means for preventing tilting and other distortions in the disc's geometry and, thus, the rotational speed of the disc in the process of writing or reading may be increased. By laminating a desired number of plates it is possible also to manufacture carriers/discs having different storage capacities. For example, when an optical disc recording medium is made by laminating two plates, it would have about half of the storage capacity of a carrier made of four plates.

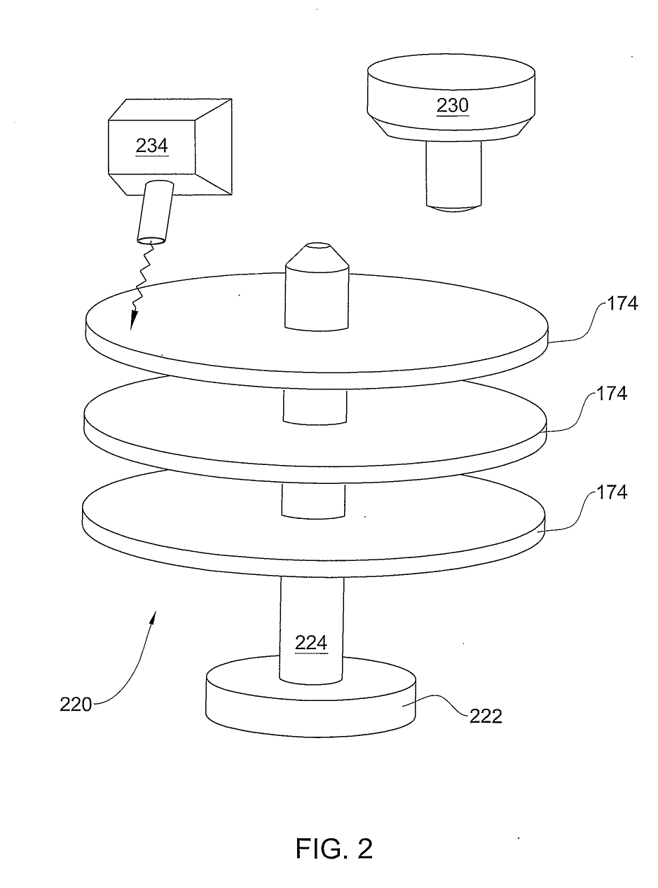

An apparatus for assembly of plates to one another, according to an embodiment of the invention, is depicted in a schematic manner in FIG. 2. Jig 220 for assembly of plates 174 includes a base 222 which carries a cylindrical post 224, having an accurate outside diameter matching inner diameter D (see FIG. 1) of bore 182 of the plates. A dispenser 230 dispenses a light, e.g. IR or UV curable adhesive to evenly cover the upper surface of the top plate. A next plate 174 is the overlaid and firmly attached to an underlying plate and then the adhesive is cured by the appropriate irradiation, which may be provided by a source irradiation 234. In case the curing is through heating, this may be achieved by an appropriate heater, e.g. a ceramic heater. The flux provided by irradiation source 234 should preferably illuminate the curable surfaces by an approximately evenly distributed radiation. The irradiation flux may be provided from one or both sides of the assembly.

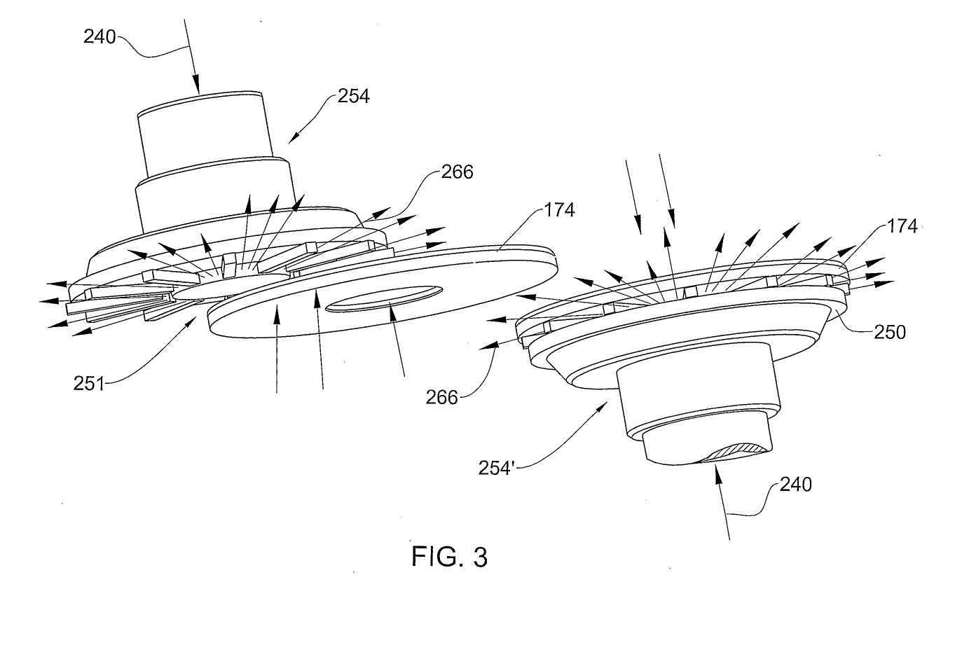

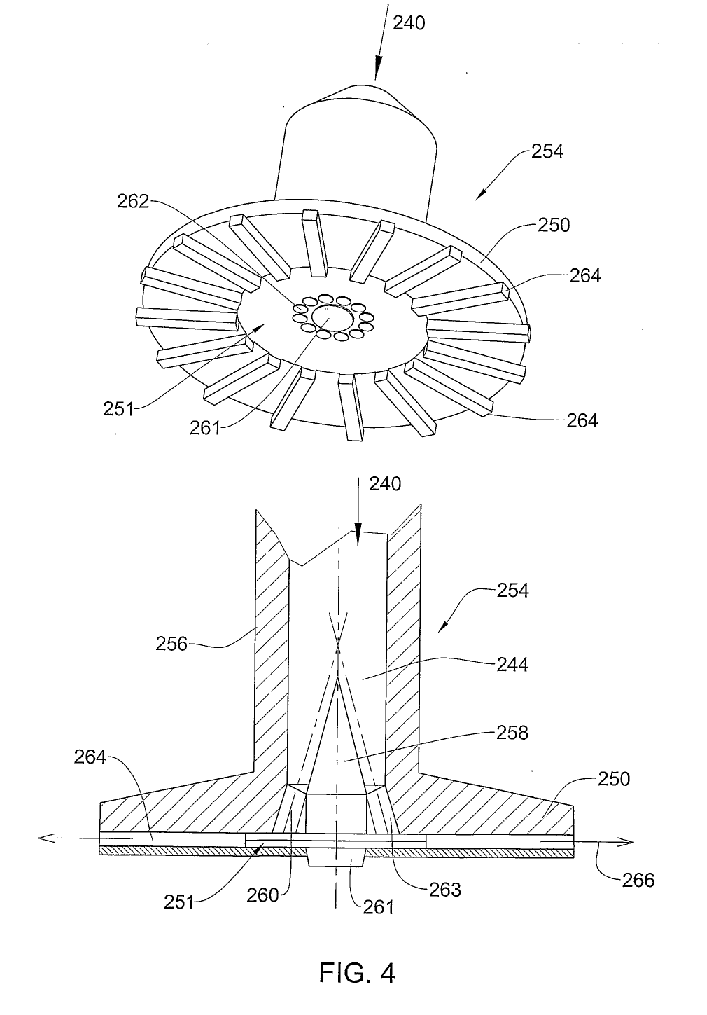

The polymer material may be sensitive to abrasions and contact handling of plates may leave scratches, pits and other that may complicate recording or reading processes. Use of pickup heads or grippers for non-contact objects handling is known in the art. One example of such pick-up head or gripper is disclosed in U.S. Pat. No. 5,871,814 to Livshits, the contents of which, at least as such relating to the mode of operation relevant to the grippers depicted in FIGS. 3 and 4, is incorporated herein by reference. This gripper of that patent is, however, not suitable for handling of parts having a bore in their central region. An improved gripper in accordance with an embodiment of the invention is shown in FIG. 3.

As can be seen particularly in FIG. 4, each gripper head, generally designated 254, has a stem 256 with an internal concentric fluid conduit 244, connected to a gas source, which may be air or any other inert gas. The terminal part of conduit 244 is fitted with a conical fluid flow guide 258. Formed at the bottom of guide 258 are a plurality of passageways 260, which have a slanted radial orientation and which end at openings 262 around a concentric abutment 261 having a diameter such so as to fit the central mounting bore of a plate 174. The griper further has an integral round bottom plate 250, the lower face of which has a plurality of radial flow-directing ribs 264 typically made of material that will not or minimally damage the plate's surface should it come in contact therewith. In use, gas pressure is introduced into conduit 244, represented by arrow 140, forcing gas flow, guided by flow guide 258 out of openings 262. Once egressing out of openings 262 into the central region 251, the gas flow is evenly distributed by the ribs into a laminar flow in a radial direction towards the periphery, guided by ribs 264. This induces a Venturi effect, a pressure below atmospheric in the vicinity of the bottom plate 250 allowing bottom plate 250 to hold plate 174 in an essentially contactless manner, while the central bore of plate 174 accommodates abutment 261.

As can be seen in FIG. 3, when fluid flow 140 is activated the below atmospheric pressure that is created thereby, permits the gripper 254 to pick up plate 174 from plate production line and deliver it to the assembly station which may be a station such as jig 220 (see FIG. 2). If necessary the orientation of plate 174 may be changed with the help of a second gripper 254′. Regulating the fluid flow through each of grippers 254 regulates the vacuum they develop and accordingly the force that holds plate 174.

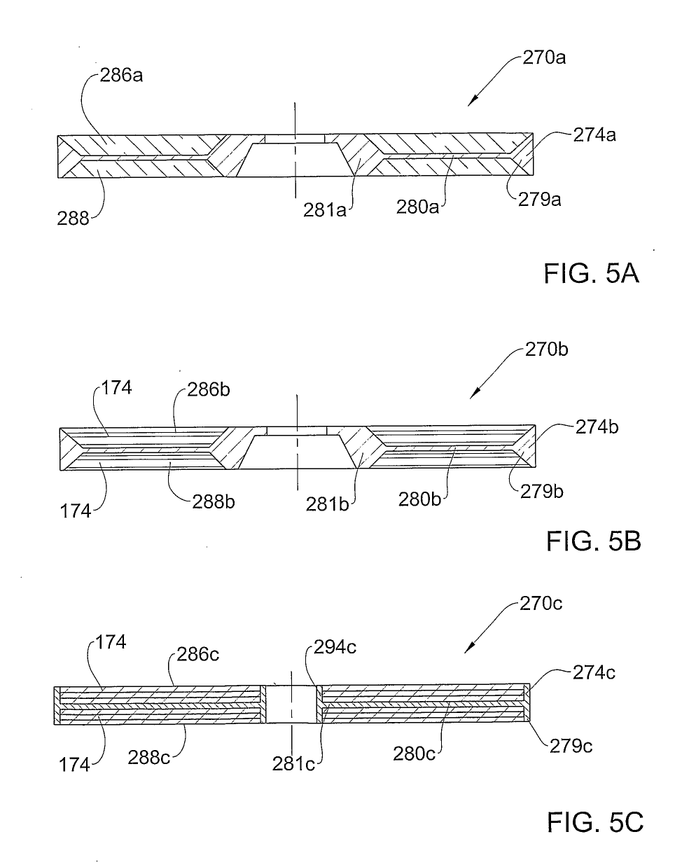

FIGS. 5A-5F illustrate other embodiments of three-dimensional optical information carriers 270a-270f, respectively. Carriers 270a-270c have reinforcing carcasses 274a-274c, respectively, which are symmetric internal carcasses. Carriers 274d-274f have internal carcasses 278d-278f, respectively, which are asymmetric external carcasses. The reinforcing carcasses 274a-274ce and 274d-274f may be made of a variety of materials of a higher strength than the polymer from which the disc is made of such as metal, plastic or composite materials. Carcass supports higher disc rotational speed and may serve, as it will be explained later as an assembly tool/jig for the assembly of plates into a carrier body.

Use of any type of reinforcing carcasses made of materials having higher strength than polymer 178 of which the recordable plates are made supports rotation of the information carrier at a speed substantially higher than carriers that do not have such reinforcing carcass. The thickness of plates 174 may thus be increased without damaging the recording/reading performance, although formation of the steady state in plates 174 should prevail over the possible plate thickness considerations.

FIGS. 5A through 5C illustrate some exemplary embodiments of a three-dimensional information carrier with symmetric carcasses 274a-274c, of which carcasses 274a and 274b have a similar structure different than 274c, have all respective peripheral portions 279a-279c, planar portions 280a-280c and central hubs 281a-281c. The central planar portions are sandwiched between respective polymeric bodies 286a-286c and 288a-288c, which may be monolithic or assembled from plates 174. Central hubs 281a-281c of symmetric carcasses 274a-274c may serve as jigs for assembly of plates 174. Similarly, central hubs 298d-298f of asymmetric carcasses 278d-278f, may serve as jigs, similar to jig 220, for assembly of plates 174. In discs 270d and 270f, the respective asymmetric carcasses 278d and 278f are of a similar design, different than the carcass 278e of disc 274e, differing from the former in having an auxiliary support member 282e.

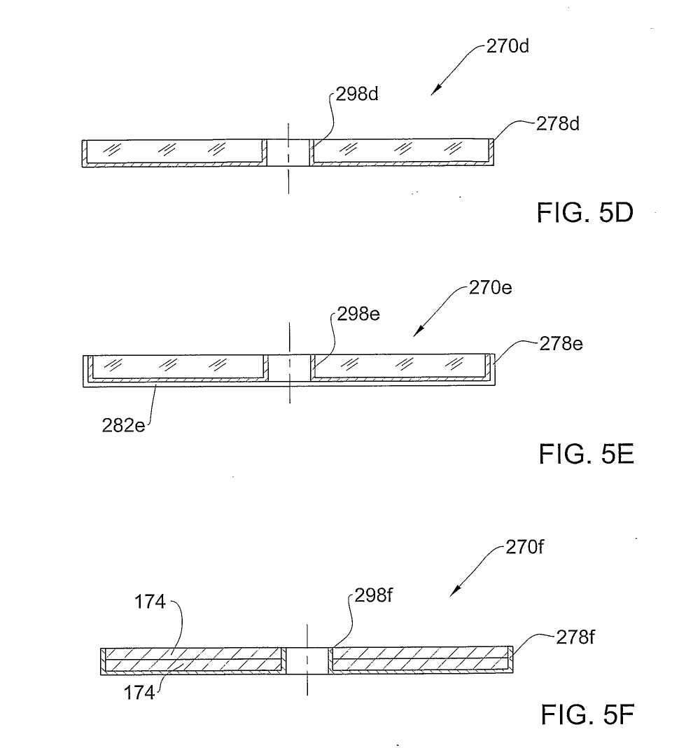

I is possible also to assemble the different plates to form the optical data carrier disc on the carcass. FIG. 6A and FIG. 6B are schematic illustrations of the manner of assembly of plates 174 on asymmetric carcass 278 and on symmetric carcass 274, respectively. Plates 174 (two are illustrated as an example, but the number of plates assembled together to form the data carrier may of course be higher) are assembled from the top in the case of carcasses 274 and from both the top and bottom in the case of carcass 278. The process is carried out in a manner that is in essence similar to the maimer of assembly on jig 220 as illustrated in FIG. 2. A dispenser dispenses a regular IR curable adhesive to apply an even layer on the surface of one plate 174. A subsequent plate 174 is overlaid and cured by thermal radiation provided by a source of IR radiation or a ceramic heater. In an alternative method, plates 174 may be preassembled to the required thickness, for example in the manner described in FIG. 2 and than the obtained assembled disc is mounted on carcasses 274 and 278. All described above properties of the carriers, like use of transparent adhesive 206, plates with different amount of irradiation-absorbing material and others are applicable, mutatis mutandis, to these as well as the other embodiments described herein.

Some of carcasses illustrated above have a central part that is configured in a hub-like form. Hubs provide convenient and accurate carrier mounting means. The three-dimensional carriers are planed for multiple and long term use. Hubs that are made of material stronger than the carrier body improve the durability of the mounting elements of the carrier. The conical surfaces of the hubs may be used as assembly jigs or tools for assembly of plates of which the carrier is produced. Dynamic balancing and thermal processing of the carrier assemblies may take place after completion of the assembly, as known per se.

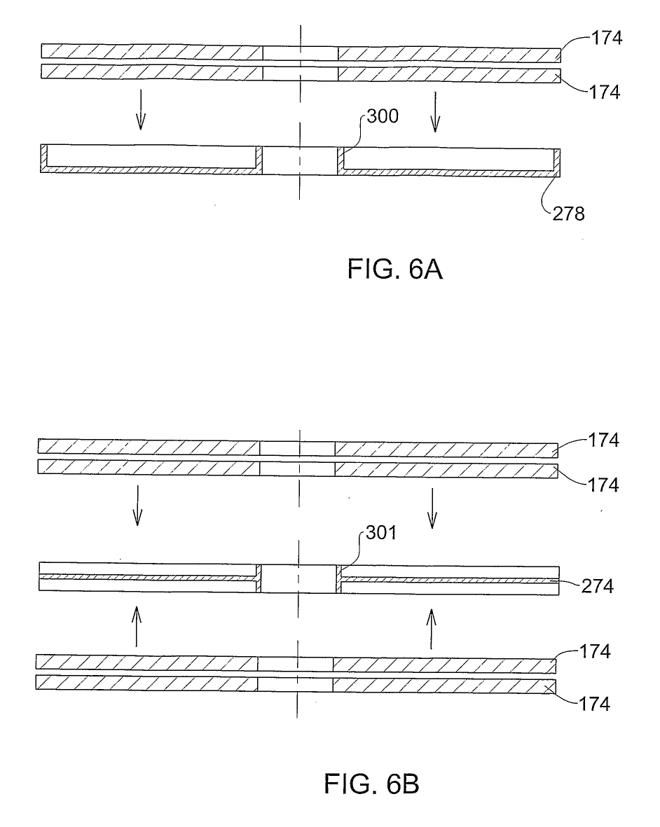

FIGS. 7A-7C are schematic illustrations of additional exemplary embodiment of respective three-dimensional information carriers 306a-306c. Plates 174 are assembled on respective hubs 308a-308c. Conical surfaces 312a-312c of hubs 308a-308c engage matching inner openings of the plates and centers plates 174 on common axes 316a-316c, which is the rotational axis of the three-dimensional carriers. Thus, hubs 308a-308c serve as assembly jigs/tools. FIG. 7C is a combination of a hub and an asymmetric carcass. Combinations of different hubs and carcasses are also possible. All the 3 hubs have upper bore portions 320a-320c of a smaller diameter than respective lower bore portions 322a-322c; the lower bore portion 322a have a conical longitudinal cross-section while that of the two others is cylindrical. When assembled on hubs 308a-308c the plates may be adhered to one another by the use of plain adhesives or such which contain active groups, as described above.

Dynamic balancing of the carrier assemblies may take place after completion of the assembly. Dynamic balancing and thermal processing of assembled carriers may be required.

The described above assembly processes may be automated and assembly lines operating simultaneously on a number of carriers could be built. The speed of the assembly of three-dimensional information carriers could be further improved by implementing the assembly process simultaneously on a large number (batch) of carriers.

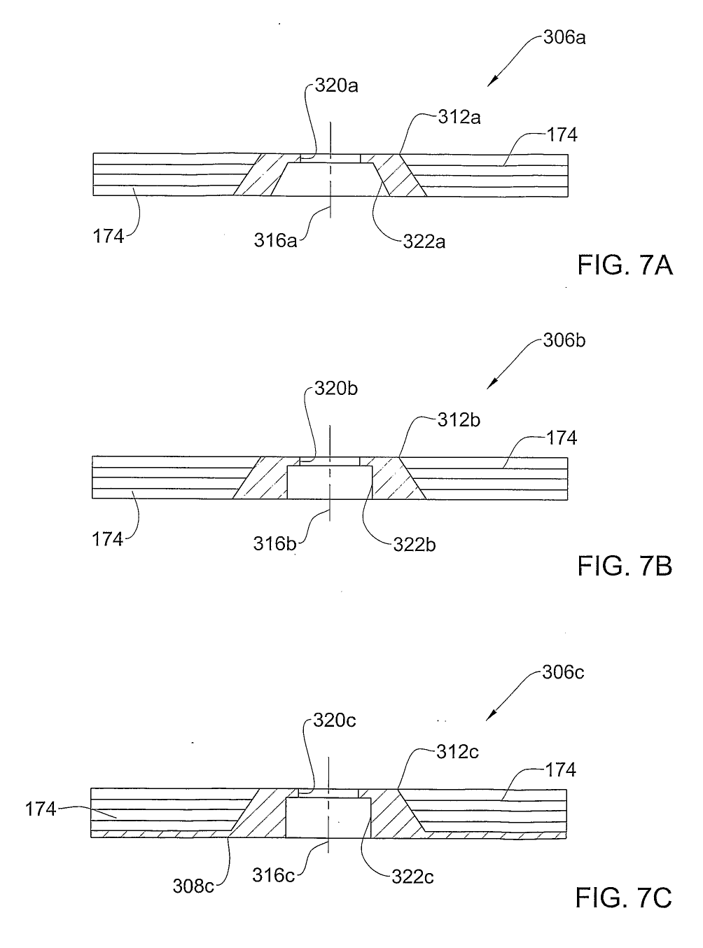

FIG. 8 is schematic illustration of a batch lamination process of polymer sheets used in manufacture of the three-dimensional information carrier. A plurality of polymer sheets 340 are produced by injection, extrusion or casting. Each sheet 340 may have the same or different amount of active groups. A loading device of any type, although non-contact handling device would be preferred, picks up sheets 340 and loads them into a laminating apparatus 350. Generally, the lamination process of sheets 340 may be performed in a conventional way by spreading between sheets 340 transparent adhesive or adhesive 206. In order to speed up the process below-atmospheric pressure and elevated temperature may be applied.

Apparatus 350 performs lamination of plates 340 by local heating of a narrow strip 354 of the boundary layer between plates 340. One or more laser devices 356 having a wavelength similar or different to the activating laser beam heats and melts a micron thin layer 354 between sheets 340. A lamp other than laser may also be configured for heating and melting the boundary between the sheets. Simultaneously with the melting process, rollers 358 apply equal pressure across the melted strip 354. This outer surface of rollers 358 require proper surface finish and cleanliness not to damage the surface of plates 340. Regular material guiding rollers 362 may be used to handle and direct the sheets before and after the lamination process. Upon completion of the lamination process, which may include lamination of more than two plates and laminated polymer sheet 344 leaves lamination apparatus 350. Subsequent process steps or the desired capacity of the carrier dictate the thickness of laminated polymer sheet 344.

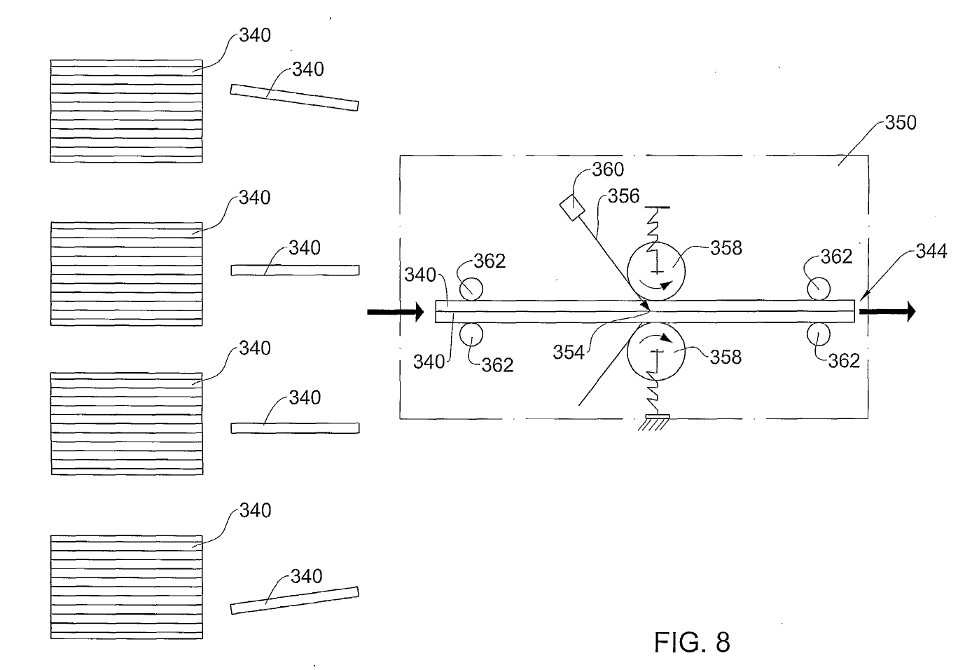

Laser 360 may be a single laser with a scanning arrangement or a plurality of lasers or laser diodes, or other suitable IR or other light sources, represented in FIG. 9A, by their beams 362 arranged such that their focal points is on the boundary 366 between sheets 340. Laser scanning and focusing methods are known per se. This technique of lamination of transparent or translucent sheets 340 allows also an expansion to the simultaneous lamination of a plurality of sheets 340, as illustrated in FIG. 9B. The heating laser beams 360 should be focused at appropriate depth to melt the desired boundary layer. Different laser powers may be required for melting boundary layers with different concentrations of active groups.

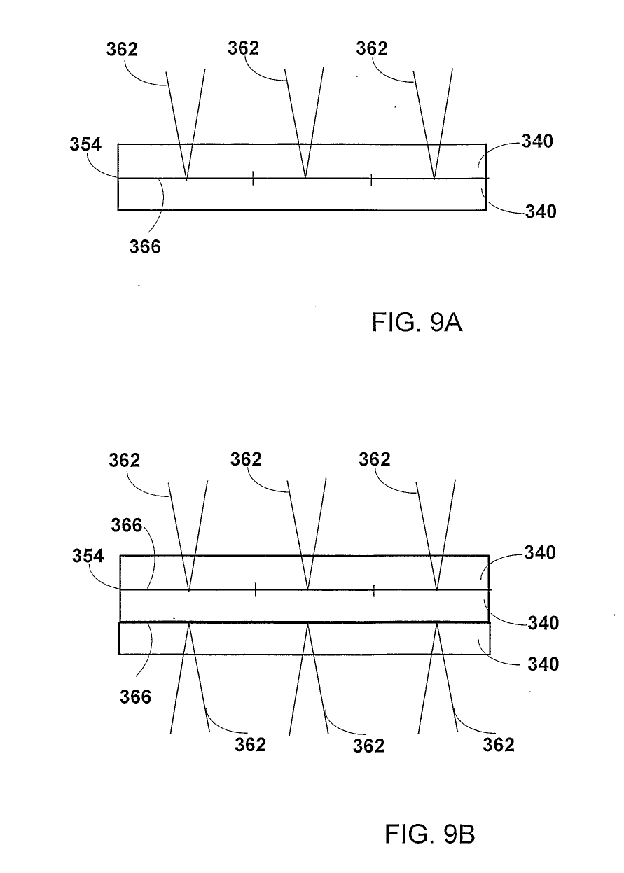

FIG. 10 is a schematic illustration of the handling of polymer sheets 340. Upon completion of the lamination process, laminated polymer sheet 344 proceeds to the next process station 366, where a plurality of laser sources 370 cuts out a plurality of carrier mounting bores 374. Laser sources may be similar to the ones used for plate lamination, although their power should be appropriate to cut through laminated assembly 344. Proper utilization of laminated polymer sheet 344 material dictates the location of nested bores 374.

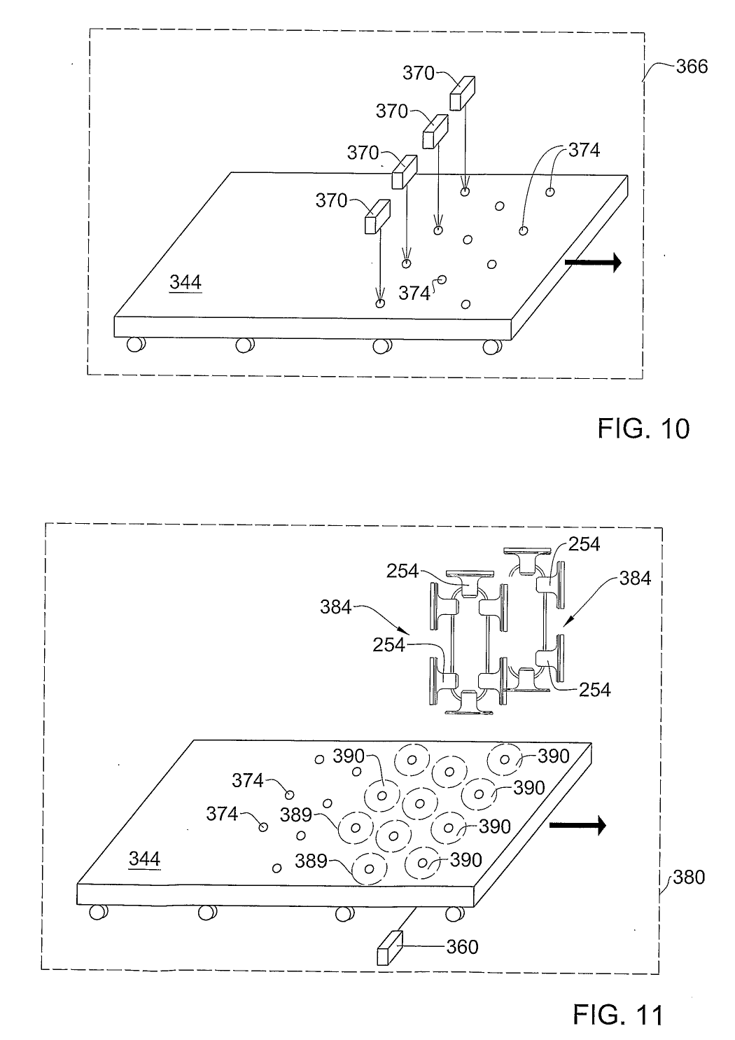

At subsequent step, laminated sheet assembly is transported to a cutout station 380. A plurality of lasers or laser diodes 362 are arranged to simultaneously produce circumferential cuts 389 around and concentric with bores 374. This is schematically illustrated in FIG. 11. For transporting grippers 254 of the kind illustrated in FIGS. 3 and 4 may be used. A plurality of grippers 254 organized in assemblies 384, insert their central abutment 261 (see FIG. 4) into bores 374 and can then pick-up the laminated sheet 344 and move it to the cutout station 380. Following the cutout a plurality of three-dimensional optical data carriers 390 are obtained. This may then be transported away by grippers 354. The residue of the laminated sheet 344 may then be disposed. Laser sources used for cutting may be similar to the ones used for plate lamination, although their power should be appropriate to cut through assembly 344. Proper laser power required for material cut through should take into account whether assembly 344 is assembled of sheets 340 that have a similar concentration of heat absorbing material or whether each of sheets 340 has a different concentration of heat absorbing material.

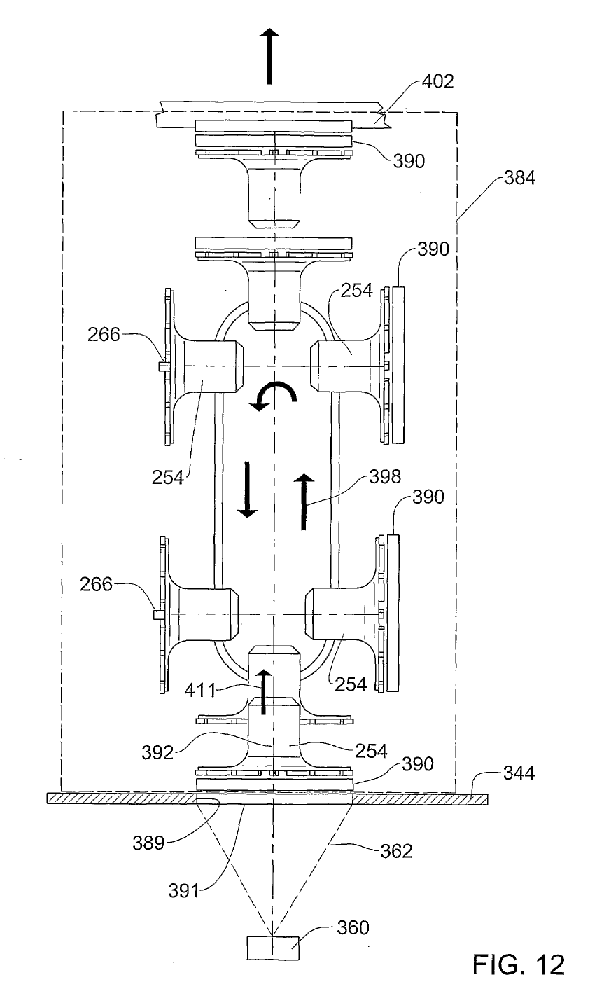

In an alternative manner of cutout of optical data carrier discs the grippers are first attached to bores 374 and the cut 389 is being made only thereafter. This is illustrated in FIG. 12. Grippers 254 are arranged in a conveyor type arrangement 384. Each abutment 261 is inserted (not shown) into respective mounting bore 374 formed in laminated sheet 344. Laser beam 362 emitted by laser 360 in a circular scanning movement cuts out along cut line 389, concentric with bore 374, yielding an optical data carrier disc 390. Gripper 254 holding carrier 390 is then retracted, as represented by arrow 411 leaving a large cutout 391 in laminated sheet 344 and a synchronization mechanism activates the movement of arrangement 384, which moves in the direction indicated by arrow 398 delivering carrier 390 to a next conveyor or pick-up device 402 that may move carrier 390 to a dynamic balancing station or to another processing station in which, for example, carrier 390 is inserted into a carcass 406.

The disclosed method of three-dimensional carriers production is a high throughput method. Methods of injection, extrusion or casting manufacturing of sheets of polymer material are well known. Each of the process stations may be implemented as an assembly line operating as a continuous process, simplifying the material handling between the stations.

1-24. (canceled)

25. A three-dimensional (3D) optical data carrier comprising a plurality of layers, characterized in that layers have different concentration of irradiation-absorbing material.

26. A 3D optical data carrier according to claim 25, wherein said irradiation is ultraviolet, visible or infrared irradiation.

27. A 3D optical data carrier according to claim 25, wherein the irradiation-absorbing material is molecule or a group of molecules that can absorb irradiation and generate heat through irradiative or convection mechanisms, emit photons through a fluorescence mechanism or undergo a conformational change.

28. A 3D optical data carrier according to claim 25, wherein the concentration of the irradiation-absorbing material increases from one surface of the data carrier towards surfaces away therefrom.

29. A 3D optical data carrier according to claim 28, wherein the concentration of the irradiation-absorbing material in different layers is selected such as to ensure equal absorption of power of an irradiating beam at different layers of said carrier.

30. A 3D optical data carrier according to claim 25, being a laminate assembled from a plurality of plates or sheets adhered to one another.

31. A 3D optical data carrier according to claim 25, wherein the plates or sheets or adhered to one another by the use of an adhesive.

32. A 3D optical data carrier according to claim 30, wherein the plates or sheets comprise sheets or plates with different concentrations of the irradiation-absorbing material than other sheets or plates in said carrier.

33. A 3D optical data carrier according to claim 30, comprising two or more groups of two or more sheets or plates each, all sheets or plates of one group have the same concentration of said material different than that of any other of said two or more groups.

34. A 3D optical data carrier according to claim 31, wherein the adhesive comprises said irradiation-absorbing material.

35. A 3D optical data carrier according to claim 31, comprising different layers of adhesive with different concentrations of said material.

36. A 3D optical data carrier according to claim 35, wherein the sheets or plates have all the same concentration of said material.

37. A 3D optical data carrier according to claim 35, wherein the sheets or plates do not contain the irradiation-absorbing material.

38. A 3D optical data carrier having an upper surface from which data is written or read, comprising an irradiation-absorbing material, characterized in that said material has different concentrations in different depth away from the upper surface.

39. A 3D optical data carrier according to claim 38, having a depth-related gradient in the concentration of the irradiation-absorbing material, with the concentration increasing in relation to the distance from the upper surface.

40. A 3D optical data carrier according tom claim 38, wherein all regions that are equidistant from the upper surface, have substantially the same concentration of the irradiation-absorbing material.

41. A 3D optical data carrier according to claim 25, wherein the thickness of each plate is in the range of about 0.1 mm to about 0.6 mm.

42. A 3D optical data carrier according to claim 25, being in the form of a disc.

43. A method for producing the 3D optical data carrier, comprising assembling and adhering a plurality of sheets or plates to one another to obtain a carrier in which different layers contain a different concentration of irradiation-absorbing material.

44. A method according to claim 43, wherein said adhering comprises applying and adhesive on at least one of two adjacent sheets.

45. A method according to claim 44, wherein said adhesive comprises said irradiation-absorbing material.

46. A method for the manufacture of three-dimensional optical data carrier, comprising:
(a) assembling transparent or translucent sheets of polymer to one another;
(b) melting boundary layers between adjacent sheets through laser irradiation such that the melted boundary layer bonds said adjacent sheets to each other to obtain a laminated sheets; and
cutting out a plurality of said carriers from said laminated sheets.
